(19) United States
(12) Patent Application Publication
(10) Pub. No.: US 2013/0076576 A1
(43) Pub. Date: Mar. 28, 2013

(54) ARRANGEMENT

(71) Applicants: Johan AVENDAL, Skivarp (SE); Anders SUNESSON, Akarp (SE)

(72) Inventors: Johan AVENDAL, Skivarp (SE); Anders SUNESSON, Akarp (SE)

(73) Assignee: LITE-ON MOBILE OYJ, VANTAA (FI)

(21) Appl. No.: 13/487,643

(22) Filed: Jun. 4, 2012

(30) Foreign Application Priority Data
Jun. 10, 2011 (FI) 20115579
Nov. 23, 2011 (FI) 20116167

(51) Int. Cl. H01Q 1/24

(52) U.S. Cl. CPC H01Q 1/241
USPC 343/702

(57) ABSTRACT

An antenna arrangement of an electronic device and a device. The arrangement includes at least two radiator elements which each are connected through a single feed element to electronics of the electronic device. A non-conductive insulation gap is arranged between the at least two radiator elements.

### BACKGROUND

The invention relates to an antenna arrangement of an electronic device.

The invention further relates to an electronic device, comprising at least two radiator elements of an antenna arrangement.

The demand for metal-cover mobile stations and corresponding electronic devices equipped with wireless data transmission properties increases all the time. This is due to the fact that the metal cover gives the impression of a strong and high-quality product.

A problem with these is that a conventional antenna arranged inside the cover cannot be used in a device with a metal cover, because the metal cover prevents an efficient operation of the antenna.

US 200810018541 discloses a solution to the above-mentioned problem in that the antenna is arranged to the cover. The solution comprises a cover antenna, multiple coupled feeds and a switch. This provides the problem that the solution is complicated and thus expensive.

### BRIEF DESCRIPTION

Viewed from a first aspect, there can be provided an antenna arrangement of an electronic device, the antenna arrangement comprising at least two radiator elements, wherein the radiator element is connected through a single feed element to electronics of the electronic device and a nonconductive insulation gap is arranged between said at least two radiator elements.

Thereby a simple and inexpensive antenna arrangement may be achieved.

Viewed from a second aspect, there can be provided an antenna arrangement of an electronic device, the antenna arrangement wherein each of the first and a second radiator elements connected through a single feed element to electronics of the electronic device, a non-conductive insulation gap arranged between said first and a second radiator elements, and that the antenna arrangement further comprising a third radiator element providing a radiator element of a secondary antenna.

Thereby an antenna arrangement possessing more directive radiation pattern than in known antenna solutions may be achieved. Thus the correlations between different radiator elements are low and antenna diversity may be advantageous.

Viewed from a further aspect, there can be provided an electronic device including at least two radiator elements of an antenna arrangement, wherein the radiator element is configured to a single feed element and a nonconductive insulation gap is arranged between said at least two radiator elements.

Viewed from a still further aspect, there can be provided an electronic device wherein each of said first and second radiator elements configured to a single feed element, a non-conductive insulation gap arranged between said first and second radiator elements, the electronic device further comprising a secondary antenna comprising a third radiator element.

The invention may also provide the advantage that correlation between different radiator elements is low, especially at low band frequencies is and, further, a radiation pattern that is more directive than in known antenna solutions.

The antenna arrangement and the cover part are characterised by what is stated in the characterising parts of the independent claims. Some other embodiments are characterised by what is stated in the other claims. Into embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In a preferred structure, the antenna arrangement comprises at least two radiator elements, the radiator element being connected through a single feed element to electronics of the electronic device and that a nonconductive insulation gap is arranged between said at least two radiator elements.

In an embodiment of the structure, the antenna arrangement comprises a first and a second radiator elements, each of the first and a second radiator elements connected through a single feed element to electronics of the electronic device, a non-conductive insulation gap arranged between said first and a second radiator elements, and that the antenna arrangement further comprising a third radiator element providing a radiator element of a secondary antenna.

In one embodiment the secondary antenna is arranged to implement a multiple-input multiple-output system, diversity antenna, WLAN antenna, UMTS antenna, WCDMA antenna, LTE antenna, CMMB antenna, FM antenna, DVB antenna and/or GPS antenna.

In one embodiment the first and the second radiator elements are connected to a first ground plane and the third radiator element is connected to a second ground plane independent from the first ground plane.

In one embodiment the secondary antenna is arranged in a circuit board on the same side thereof with the first and the second radiators.

In one embodiment the first ground plane is arranged such that the first and the second radiators are placed on first side of the first ground plane and the third radiator on opposite side of said first ground plane.

In one embodiment the first ground plane is arranged in a circuit board.

In one embodiment the third radiator is formed in a display unit of the electronic device.

In one embodiment a height element is arranged to form a height between the third radiator and a second ground plane.

In one embodiment the secondary antenna is a monopole antenna.

In one embodiment the secondary antenna is a F-antenna.

In one embodiment the secondary antenna is a PIFA-antenna.

In one embodiment the secondary antenna is a loop antenna.

In another embodiment, an electronic device comprises a first and a second radiator element of an antenna arrangement, each of said first and second radiator elements configured to a single feed element, a non-conductive insulation gap arranged between said first and second radiator elements, the electronic device further comprising a secondary antenna comprising a third radiator element.

In one embodiment the radiator elements are made of metal, such as aluminium, zinc, steel, magnesium, copper or an alloy.

In one embodiment the material of the radiator element is an electrically conductive plastic or plastic mixture.

In one embodiment the radiator elements comprise metal and plastic.

In one embodiment the radiator elements are part of a cover of said electronic device.

In one embodiment the insulation gap comprises an air gap.

In one embodiment the insulation gap comprises plastic.

In one embodiment the feed elements are galvanically coupled elements.

In one embodiment the feed elements are capacitively coupled elements.

In one embodiment the feed elements are inductively coupled elements.

In one embodiment the ground plane of the antenna arrangement is configured to a circuit board, display unit or battery of the device.

In one embodiment the radiator elements are part of a wrap structure establishing an interior in the electronic device.

In another preferred structure, an electronic device comprises at least two radiator elements of an antenna arrangement, the radiator element is configured to a single feed element and that a non-conductive insulation gap is arranged between said at least two radiator elements.

In one embodiment the radiator elements form a major part of the outer surface of the cover.

In one embodiment the radiators form a major part of the outer surface of the back cover.

In one embodiment the insulation gap is arranged on back cover side of the cover part.

In one embodiment the radiator elements are part of a wrap structure establishing an interior in the electronic device.

In one embodiment the wrap structure is arranged to establish a grounding element.

### BRIEF DESCRIPTION OF FIGURES

Some embodiments illustrating the present disclosure are described in more detail in the attached drawings, in which

FIG. 1 is a schematic view of an example antenna arrangement,

FIG. 2 is a schematic side view of an example antenna arrangement and electronic device in partial cross-section,

FIG. 3 is a schematic side view of another example antenna arrangement and electronic device in partial cross-section,

FIGS. 4a-7b are schematic representations of e-fields and h-fields of an example antenna arrangement,

FIGS. 8a-8b are schematic representations of radiation patterns of an example antenna arrangement, and

FIG. 9 is a schematic side view of an example antenna arrangement and electronic device in partial cross-section,

FIG. 10 is a schematic side view of another example antenna arrangement and electronic device in partial cross-section,

FIG. 11 is a schematic side view of third example antenna arrangement and electronic device in partial cross-section,

FIG. 12 is a schematic side view of fourth example antenna arrangement and electronic device in partial cross-section, and

FIGS. 13a, 13b are a schematic views of fifth example antenna arrangement and electronic device in partial cross-section.

In the figures, some embodiments are shown simplified for the sake of clarity. Similar parts are marked with the same reference numbers in the figures.

### DETAILED DESCRIPTION

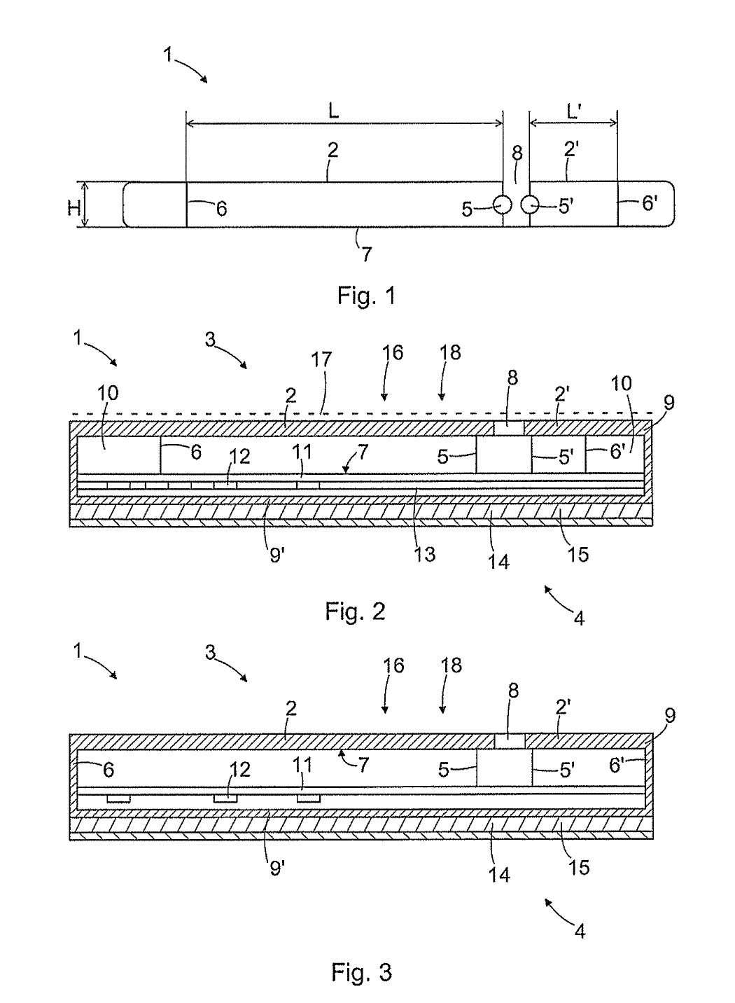

FIG. 1 is a schematic view of an example antenna arrangement. The antenna arrangement 1 may be a part of an electronic device, which is discussed later in this description.

The antenna arrangement 1 may be a part of a mobile phone, some other portable or fixedly positioned communication means that functions at least partially wirelessly, such as a communicator, or some other portable electronic device, such as a palmtop computer, portable computer, game console or controller, playback device for audio and/or visual material, pulse counter, code reader, transmitter and/or receiver intended for measuring purposes and functioning wirelessly, or the like.

The antenna arrangement 1 comprises a first radiator element 2 and second radiator element 2′. It is to be noted that the antenna arrangement 1 may comprise more than two radiator elements.

The radiator elements 2, 2′ may be made of the same material, preferably of sheet of metal, such as aluminium, zinc, steel, stainless steel, magnesium, copper or an alloy. Alternatively, the material of the radiator element 2, 2′ is an electrically conductive plastic or plastic mixture made electrically conductive by doping a conductive material (metal, ceramics, carbon in various forms, etc.) in it. The radiator element 2, 2′ may also be manufactured of any combinations of materials listed above, e.g. as a combination of metal and plastic. The radiator element 2, 2′ may have a non-layered structure or a layered structure. The layered structure may be a laminated structure or any plated or metallized structure. For example, a LDS technique (Laser Direct Structuring) or some other MID technique (Moulded Interconnect Device) may be used. In said techniques a non-conductive substrate is plated selectively with metal.

The quality factor of the antenna arrangement may further be improved by arranging a thin layer of copper or silver, or a mixture containing them, or some other particularly electrically conductive material on the surface of the radiator elements 2, 2′.

The resonance frequency ranges of the radiator elements 2, 2′ and the antenna arrangement 1 may be matched by dimensioning the radiator elements 2, 2′ and by matching elements.

The basic form of the radiator element 2, 2′ may be a rectangle. The radiator elements 2, 2′ have a certain length that in FIG. 1 is marked with reference L, L′. The length means distance between grounding element 6, 6′ and an insulation gap 8 where it is situated an edge of the radiator element 2, 2′, respectively.

The first radiator element 2 is notably longer that the second radiator element 2′. The first radiator element 2 may be tuned to lower band resonance frequency range and the second radiator element to higher band resonance frequency range. The lengths L, L′ of the radiator elements may be, for instance, 70 mm and 20 mm, respectively. According to an embodiment the length L, L′ is approximately equal to the wavelength of respective resonance frequency. It is to be noted that the lengths may be dimensioned differently. The width of the first radiator element 2 may be equal to the width of the second radiator element 2′.

The resonance frequencies of the antennas are typically in the frequency range of 400 MHz to 2.5 GHz. They may be adapted to one or more GSM frequency ranges, GSM 850, GSM 900, GSM 1800 and/or GSM 1900, or to a frequency range according to Wi-Fi, Wlan, UMTS, WCDMA, LTE or some other corresponding wireless network technique, for instance. Naturally, other suitable higher frequencies and frequency ranges are also possible.

As stated above, the radiator elements are abutted on the insulation gap 8. The width of the insulation gap may be about 0.1 to 20 mm. The insulation gap 8 is electrically non-conductive and it may be an air gap or it may contain some electrically non-conductive material, typically polymer material. The insulation gap 8 may be of the same width throughout, or alternatively, its width may vary. It also may comprise two or more materials; for instance, sections of air and polymeric elements there between.

Each of the radiator elements 2, 2′ is connected through a single feed element 5, 5′, respectively, with or without a matching element and/or a diplexer, to electronics of the electronic device, i.e. to antenna port of the device. Thus the structure of the antenna arrangement 1 is simple. Said electronics may be arranged to a circuit board, such as PWB (Printed Wiring Board). Said feed elements 5, 5′ are configured to reception and/or transmission of electromagnetic signals at different frequencies.

The feed element 5, 5′ may comprise a galvanically coupled element, e.g. conducting pins, such as pogo-pins, C-springs etc.

Alternatively, the feed element 5, 5′ may comprise a capacitive or inductive coupling between the radiator element 2, 2′ and the antenna port.

Matching elements, if any, for matching the resonance frequency ranges of the radiator elements 2, 2′ are preferably arranged to near to the antenna port. The antenna port may be located on circuit board, for instance.

The radiator elements 2, 2′ are connected to a ground plane 7 through grounding elements 6, 6′ respectively. Thus, the radiator elements 2, 2′ are in short-circuit with the ground plane 7. The ground plane 7 may be arranged to the circuit board of the device.

Height H, that is distance between the radiator element 2, 2′ and the ground plane 7, may be several millimetres, for instance 3 mm. The height may have an important contribution to band width of the resonating bands.

FIG. 2 is a schematic side view of an example antenna arrangement and cover part in partial cross-section.

The radiator elements 2, 2′ are part of a cover 3 of the electronic device 4. The radiators 2, 2′ may form at least part, or even a major part, of the outer surface of the cover 3. In the embodiment shown in FIG. 2 the radiator elements 2, 2′ form a major part of the outer surface of a back cover of the electronic device 4. The insulation gap 8 is arranged on back cover side of the cover 3. This kind of layout has been observed to give low head loss and minimum SAR problems. It is self-evident that the layout may vary from the embodiment shown in FIG. 2.

In another embodiment the radiator elements 2, 2′ are arranged inside the electronic device, i.e. separate from and covered by the cover part of the device. The cover part may be manufactured from plastic or some other material permeable to the fields of the radiator elements 2, 2′.

The radiator elements 2, 2′ are part of a wrap structure 9 that surrounds an interior 16 of the device on backside, frontside and ends of said interior, but not lateral sides of said interior 16. The wall of the wrap structure 9 may have a constant thickness or it may have thinner and thicker sections as shown in FIG. 2.

A portion of components of the electronic device 4 may be arranged in the interior 16. Such components may comprise, for instance, circuit board(s) 11, a battery 18, electronic component(s) etc. The components may be shielded by shielding barriers in order to avoid disturbances between said components and other components of the device 4.

Large components or components that may affect negatively to performance of antennae may be preferably arranged in grounded areas 10.

In embodiment shown in FIG. 2, a circuit board 11 together with electric components 12 therein are arranged in the interior 16. Also feed elements 5, 5′, grounding elements 6, 6′ and ground plane 7 are in the interior 16.

In another embodiment the ground plane 7 may be arranged in section 9′ of the wrap structure 9 being situated opposite to the radiator elements 2, 2′. In another embodiment, the ground plane 7 may also be arranged in a main circuit board, an auxiliary circuit board, a battery, a display and/or other large enough area of conductive material.

A display unit 14 and protecting window unit 15 are arranged outside the interior 16. On back side of the device 4 there is an optional coating 17 for protective and/or decorative purpose(s).

FIG. 3 is a schematic side view of another example antenna arrangement and electronic device in partial cross-section. The structure of this embodiment differs from the embodiment shown in FIG. 2 in that both the grounding elements 6, 6′ and the ground plane 7 are arranged in the wrap structure 9. This structure is extremely simple and advantageous to manufacture.

In another embodiment there is a separate grounding element 6, 6′ on one side of the insulation gap 8 only. Another side may then be grounded by the wrap structure 9.

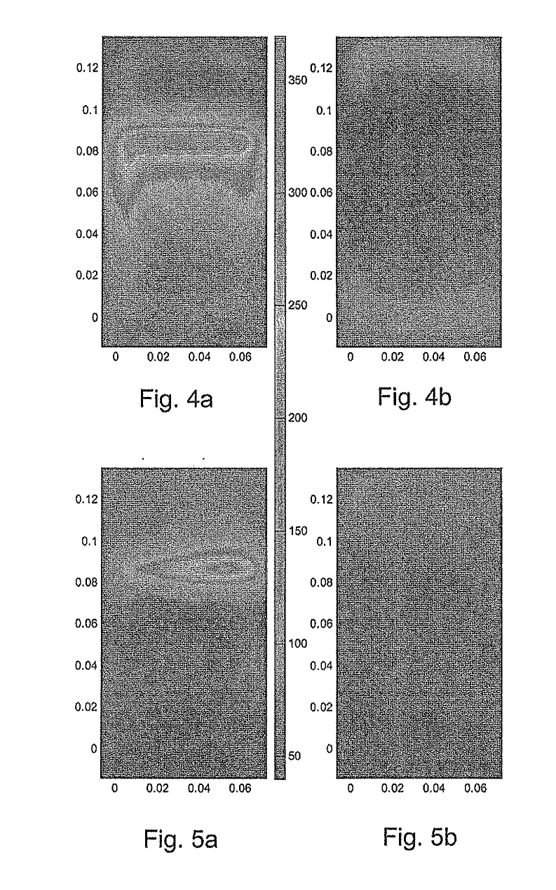

FIGS. 4a-7b are schematic representations of e-fields and h-fields of an example antenna arrangement. The antenna arrangement was manufactured from a 0.5 mm thick copper plate folded to a wrap structure. The outer dimensions of the wrap structure were 125 mm×60 mm×9 mm (length×width×height).

FIGS. 4a and 4b are showing electric field (e-field) at 890 MHz on back side and front side of a device, respectively.

FIGS. 5a and 5b are showing electric field at 1940 MHz on back side and front side of a device, respectively.

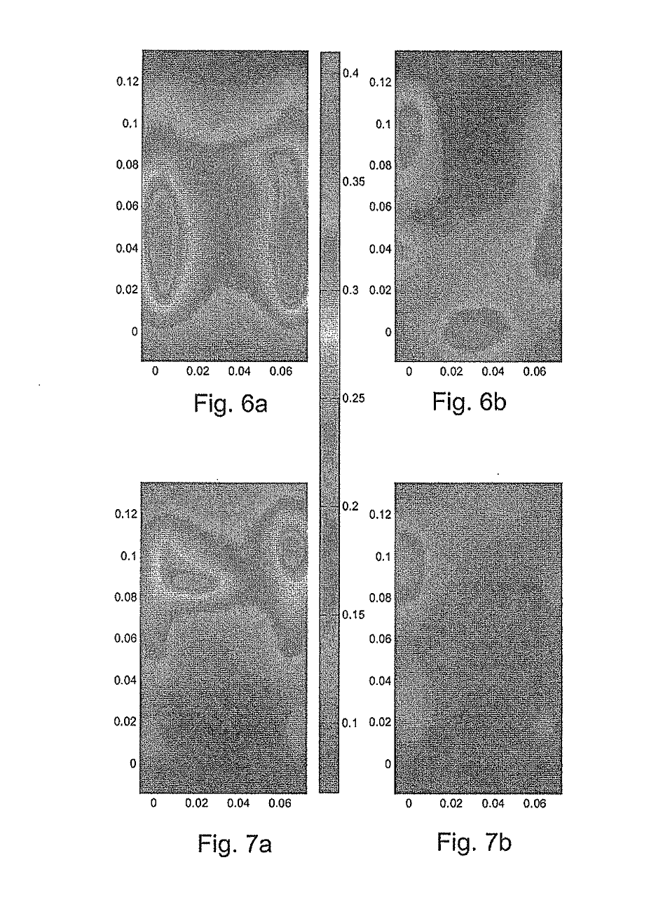

FIGS. 6a and 6b are showing magnetic field (H-field) at 890 MHz on back side and front side of a device, respectively.

FIGS. 7a and 7b are showing magnetic field at 1940 MHz on back side and front side of a device, respectively.

Table 1 is showing results of average total efficiency of the antenna arrangement measured in a Satimo 24 anechoic measurement chamber. The radiators 2, 2′ were directed away from a head model.

TABLE 1

Average total efficiency [dB]

| | Low band/Drop | High band/Drop |
|---|---|---|
| | compared to FS | compared to FS |
| Free space | −2.2 | −3.6 |
| Beside head | −4.7/2.5 | −4.0/0.4 |
| Hand position | −9.2/7.0 | −7.0/3.4 |
| Beside head + hand | −11.9/9.7 | −9.9/6.3 |

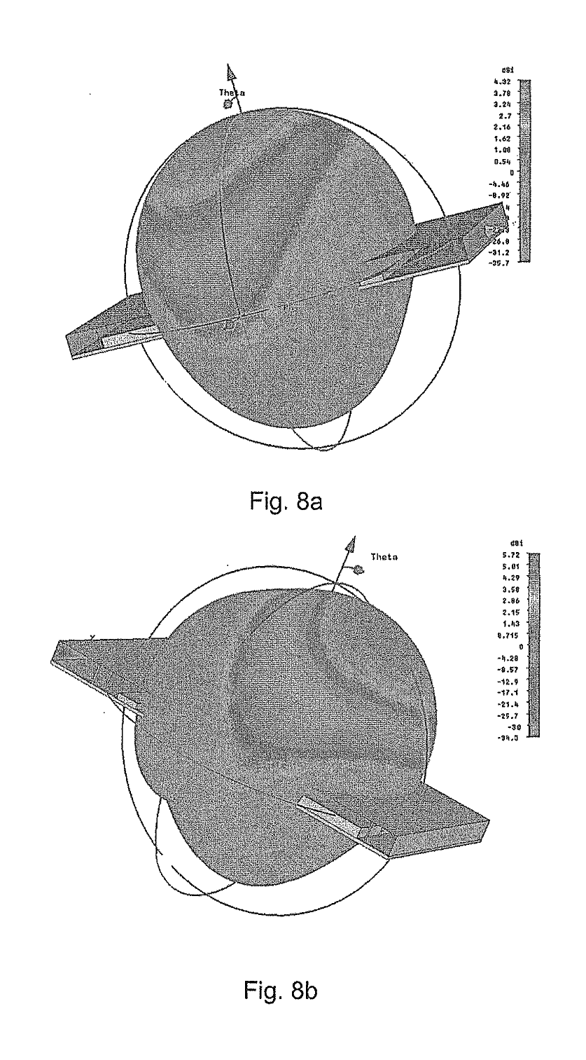

As it can be seen, drop of efficiency beside head is especially low. This is due to radiation pattern which can be seen in FIGS. 8a, 8b. The radiation pattern is mainly directed away from head, i.e. in the side of the radiators 2, 2′. Said drop is typically notably higher in known antenna arrangements due to their more dipole-like or omnidirectional radiation pattern. It is to be noted that “FS” stands for Free Space. In a known antenna arrangements used in electronic devices, especially in mobile phones, currents on the ground plane contribute the most of the radiation at 700-1000 MHz. The antenna arrangements according to the invention operate differently. The currents are very low at the ground plane as can be seen in FIG. 5b for low band and in FIG. 6b for high band. The currents are instead localized at the radiator elements 2, 2′.

This means that most of the radiation of the radiation pattern is directed to the side of the radiator elements 2, 2′, not to the opposite side of the ground plane 7. This can be seen in FIGS. 8a, 8b. As a result, the current distribution and radiation pattern of the antenna arrangement according to the invention is fundamentally different from known antenna arrangements.

Thus advantageous correlations can be achieved if the antenna arrangement according to the invention is combined with a known antenna arrangement.

FIGS. 8a-8b are schematic representations of radiation patterns of an example antenna arrangement.

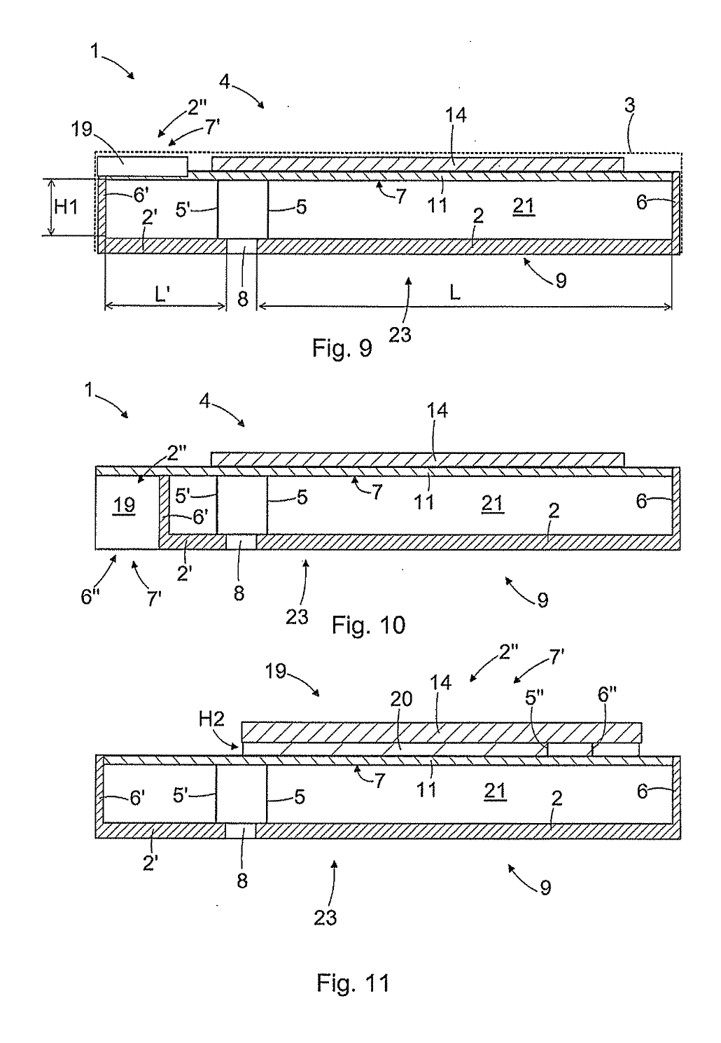

FIG. 9 is a schematic side view of an example antenna arrangement and electronic device in partial cross-section,

The antenna arrangement 1 is a part of an electronic device 4. Said electronic device 4 may be a mobile phone, some other portable or fixedly positioned communication means that functions at least partially wirelessly, such as a communicator, or some other portable electronic device, such as a palmtop computer, portable computer, game console or controller, playback device for audio and/or visual material, pulse counter, code reader, transmitter and/or receiver intended for measuring purposes and functioning wirelessly, or the like.

The antenna arrangement 1 comprises a first radiator element 2, a second radiator element 2′, and a third radiator element 2″′. It is to be noted that the antenna arrangement 1 may also comprise more than said three radiator elements.

The first and second radiator elements 2, 2′ are radiators of a main antenna 23 and belongs to a wrap structure 9 that surrounds an interior 21 of the device on backside, frontside and ends of said interior, but not lateral sides of said interior 21. It is to be noted, however, that according to an embodiment at least one of the radiator elements 2, 2′ comprise a side section that are folded on lateral sides of the interior 21. The side section may extend along the whole length of the radiator element 2, 2′ or, alternatively, the side section may be shorter than the radiator element 2, 2′.

The wall of the wrap structure 9 may have a constant thickness or it may have thinner and thicker sections as shown in FIG. 10. The wrap structure 9 may be composed of one piece or element or, alternatively, of two or more pieces.

A portion of components of the electronic device 4 may be arranged in the interior 21. Such components may comprise, for instance, circuit board(s), a battery, electronic component(s) etc. The components may be shielded by shielding barriers in order to avoid disturbances between said components and other components of the device 4.

As shown in FIG. 9, a circuit board 11 may be arranged to be a part of said wrap structure 9 defining the interior 21. A first ground plane 7 that forms the ground of the first and the second radiator elements 2, 2′ may be arranged in the circuit board 11. The circuit board 11 is here a main circuit board of the electronic device 4. Alternatively, the first ground plane 7 may be arranged in an auxiliary circuit board, a battery, a display and/or other large enough area of conductive material.

All the radiator elements 2, 2′, 2″ may be made of the same material, preferably of sheet of metal, such as aluminium, zinc, steel, stainless steel, magnesium, copper or an alloy. Alternatively, the material of the radiator element 2, 2′, 2″ is an electrically conductive plastic or plastic mixture made electrically conductive by doping a conductive material (metal, ceramics, carbon in various forms, etc.) in it. The radiator element 2, 2′, 2″ may also be manufactured of any combinations of materials listed above, e.g. as a combination of metal and plastic.

The radiator element 2, 2′, 2″ may have a non-layered structure or a layered structure. The layered structure may be a laminated structure or any plated or metallized structure. For example, a LDS technique (Laser Direct Structuring) or some other MID technique (Moulded Interconnect Device) may be used. In said techniques a non-conductive substrate is plated selectively with metal.

The quality factor of the antenna arrangement 1 may further be improved by arranging a thin layer of copper or silver, or a mixture containing them, or some other particularly electrically conductive material on the surface of the radiator elements 2, 2′, 2″.

The resonance frequency ranges of the radiator elements 2, 2′, 2″ and the antenna arrangement 1 may be matched by dimensioning the radiator elements 2, 2′, 2″ and by matching elements known per se. It is to be noted that matching elements are not shown in the figures.

The basic form of the first and the second radiator element 2, 2′ may be a rectangle. Said radiator elements 2, 2′ have a certain length that in FIG. 9 is marked with reference L, L′. The length means distance between grounding element 6, 6′ and an insulation gap 8 where it is situated an edge of the radiator element 2, 2′, respectively. The width, i.e. dimension in direction of normal of the Figures, of the first radiator element 2 may be equal the width of the second radiator element 2′ or, alternatively, one of the elements 2, 2′ is wider than another.

The grounding element 6, 6′ may have equal width with corresponding radiator element 2, 2′ or, alternatively, the grounding element 6, 6′ is narrower in said direction. The grounding element 6, 6′ may be, for instance, c-spring, pogo pin etc.

The first radiator element 2 is notably longer that the second radiator element 2′. The first radiator element 2 may be tuned to lower band resonance frequency range and the second radiator element to higher band resonance frequency range. The lengths L, L′ of the radiator elements may be, for instance, 70 mm and 20 mm, respectively. According to an embodiment the length L, L′ is approximately equal to the half wavelength of respective resonance frequency. It is to be noted that the lengths may be dimensioned differently.

The first and the second radiator elements 2, 2′ shown in Figures have a planar and rectangular basic shape. According to another embodiment said radiator elements 2, 2′ may comprise shapes that are at least to some extent three-dimensional.

The third radiator 2″ is a radiator of a secondary antenna 19. Said secondary antenna 19 may be for instance, a diversity antenna that improves the quality and reliability of transmission and/or receiving of radiating energy processed through the first and/or second antenna (e). The term “antenna diversity” means at least one of the following types of diversity: spatial diversity, pattern diversity, polarization diversity and transmit/receive diversity.

The antenna arrangement 1 may also be adapted to implement a multiple-input multiple-output (MIMO) system. Also other embodiments of the antenna arrangement 1 discussed in this specification may implement MIMO system.

In the embodiment shown in FIG. 9 is the secondary antenna 19 arranged in the circuit board 11 and on opposite side thereof with relation to the first and the second radiators 2, 2′.

The secondary antenna 19 may be implemented several alternative ways. It may be basically, for instance, a monopole antenna, an F-antenna, a PIFA-antenna or a loop antenna.

The radiator of the secondary antenna 19, i.e. the third radiator 2″ may be oriented or directed various alternative ways relative to the first and the second radiators 2, 2′. According to an embodiment, the third radiator 2″ is arranged parallel with the first and the second radiators 2, 2′.

According to another embodiment, the third radiator 2″ is arranged orthogonally relative to the first and the second radiators 2, 2′. The orthogonally arranged third radiator 2″ may be arranged in a plane that is parallel with the length direction of the first and the second radiator 2, 2′. Alternatively, the orthogonally arranged third radiator 2″ may be arranged in a plane that is parallel with the width direction of the first and the second radiator 2, 2′. Still alternatively, the orthogonally arranged third radiator 2″ may be arranged in a plane that is not parallel with the length or width directions of the first and the second radiator 2, 2′, e.g. in a plane that is diagonal and orthogonal compared to the plane of the first and the second radiator 2, 2′.

According to still another embodiment, the third radiator 2″ is arranged slant, for instance ±45°, compared to the plane of the first and the second radiator 2, 2′.

Also the ground plane of the secondary antenna 19 may be arranged in above-mentioned positions or orientations compared to the plane of the first ground plane 7. It is to be noted that the ground plane of the secondary antenna 19 is referred to a second ground plane 7′ in this description.

The resonance frequencies of the antennae are typically in the frequency range of 400 MHz to 2.7 GHz, at least. They may be adapted to one or more GSM frequency ranges, GSM 850, GSM 900, GSM 1800 and/or GSM 1900, or to a frequency range according to Wi-Fi or other WLAN (Wireless Local Area Network), UMTS (Universal Mobile Telecommunications System), WCDMA (Wideband Code Division Multiple Access), LTE (Long Term Evolution), GPS (Global Positioning System), NFC (Near Field Communication) CMMB (China Multimedia Mobile Broadcasting), FM (Frequency Modulation), DVB (Digital Video Broadcasting) or some other corresponding wireless network technique, for instance. Naturally, other suitable higher frequencies and frequency ranges are also possible. According to an embodiment it is the secondary antenna 19 that is used as antenna for Wi-Fi, WLAN, UMTS, WCDMA, LTE, NCF, CMMB, FM, DVB and/or GPS.

The first and the third radiator elements 2, 2′ are abutted on the insulation gap 8. The width of the insulation gap may be about 0.1 to 20 mm, preferably 0.5 to 4 mm. The insulation gap 8 is electrically non-conductive and it may be an air gap or it may contain some electrically non-conductive material, typically polymer material. The insulation gap 8 may be of the same width throughout, or alternatively, its width may vary. It also may comprise two or more materials; for instance, sections of air and polymeric elements there between.

Each of the first and the second radiator elements 2, 2′ may be connected through a single feed element 5, 5′, respectively, with or without a matching element and/or a diplexer, to electronics of the electronic device, i.e. to antenna port(s) of the device. Also the third radiator element 2″ is connected through a third feed element 5″, with or without a matching element and/or a diplexer, to electronics of the electronic device, i.e. to an antenna port of the device. It is to be noted that the third feed element is not shown in FIG. 9.

The first and the second feed elements 5, 5′ are connected to the respective radiator element 2, 2″ close to the slot 8, preferably at the end of the slot 8. Furthermore, the first feed element 5 is arranged as far away as possible from the second feed element 5′. According to an embodiment the first feed element 5 is arranged at first end of the slot 8 whereas the second feed element 5′ is arranged at opposite end of the slot 8. This way the isolation of the feeds from each other may be optimized.

The feed elements are configured to reception and/or transmission of electromagnetic signals at different frequencies. The feed element may comprise a galvanically coupled element, e.g. conducting pins, such as pogo-pins, C-springs etc. Alternatively, the feed element may comprise a capacitive or inductive coupling between the radiator element and the antenna port.

Matching elements, if any, for matching the resonance frequency ranges of the radiator elements 2, 2′, 2′″ are preferably arranged close to the respective antenna port. The antenna port may be located, for instance, on the circuit board 11.

The first and the second radiator elements 2, 2′ are connected to the first ground plane 7 through grounding elements 6, 6′ respectively. Thus, the first and the second radiator elements 2, 2′ are in short-circuit with the first ground plane 7. The first ground plane 7 may be arranged, for instance, to the circuit board 11.

First height H1, that is distance between the first and the second radiator elements 2, 2′ and the first ground plane 7, may be several millimetres, for instance 3 mm or 4 mm. The first height H1 may have an important contribution to band width of the resonating bands.

The secondary antenna 19 comprises a second ground plane 7′ that establishes a ground for the third radiator element 2″. The third radiator element 2″ may be connected to the second ground plane 7′ through at least one grounding element.

The second ground plane 7′ may be arranged, for instance, to the circuit board 11. According to an embodiment, the second ground plane 7′ is independent from the first ground plane 7. This means that the second ground plane 7′ may be electrically isolated from the first ground plane 7. It is also possible that the first and the second ground planes 7, 7′ are one and the same.

A display unit 14 is arranged outside the interior 21. In another embodiment, the display unit 14 act as a ground plane.

The first and the second radiator elements 2, 2′ may be part of a cover 3 of the electronic device 4. Said radiator elements 2, 2′ may form at least part, or even a major part, of the outer surface of the cover 3. In the embodiment shown in FIG. 9 the first and the second radiator elements 2, 2′ form a major part of the outer surface of a back cover of the electronic device 4. The insulation gap 8 is arranged on back cover side of the cover 3. This kind of layout has been observed to give low head loss and minimum SAR problems. It is self-evident that the layout may vary from the embodiment shown in FIG. 9.

In another embodiment the first and the second radiator elements 2, 2′ are arranged inside the electronic device, i.e. separate from and covered by the cover 3 of the device. The cover 3 may be manufactured from plastic or some other material permeable to the fields of the radiator elements.

Also the secondary antenna 19, especially but not solely the third radiator element 2″, may form a part of the outer surface of the cover 3.

FIG. 10 is a schematic side view of another example antenna arrangement and electronic device in partial cross-section.

The main difference between the antenna arrangements 1 shown in FIGS. 1 and 2 is that in FIG. 10 the secondary antenna 19 is arranged in a circuit board 11 on the same side thereof with the first and the second radiators 2, 2′. The type of the secondary antenna 19 and its layout may vary as described earlier in the description of FIG. 9.

FIG. 11 is a schematic side view of third example antenna arrangement and electronic device in partial cross-section.

The first and the second radiator elements 2, 2′ are placed on first side of the first ground plane 7 and the secondary antenna 19 on opposite side of said first ground plane 7. The first ground plane 7 may be arranged, for instance, in the circuit board 11.

The third radiator element 2″ is formed in a display unit 14 of the electronic device 4. The display unit 14 may comprise, for instance a LCD-display, TFT-display, OLED-display, such as AMOLED-display or some other display known per se. The third radiator element 2″ may be attached or manufactured directly to the display unit 14 or the display as such may be used as the third radiator element 2″.

A height element 20 is arranged to establish a second height H2 between the third radiator element 2″ and the second ground plane 7′ arranged on the circuit board 11.

The height element 20 keeps the third radiator element 2″ in the right place and at the right height in respect of the second ground plane 7′ The third radiator element 2″ is connected to an antenna feed through a third feed element 5″ as discussed earlier in this description. The third radiator element 2″ may be grounded to the second ground plane 7′ through one or more third grounding element(s) 6″. The need for the grounding depends on the type of the secondary antenna 19.

According to another embodiment, also the second ground plane 7′ is arranged in the display unit 14.

According to another embodiment, the third radiator 2″ and/or the second ground plane 7′ may be arranged to a battery or some other suitable dimensioned and designed component of the device.

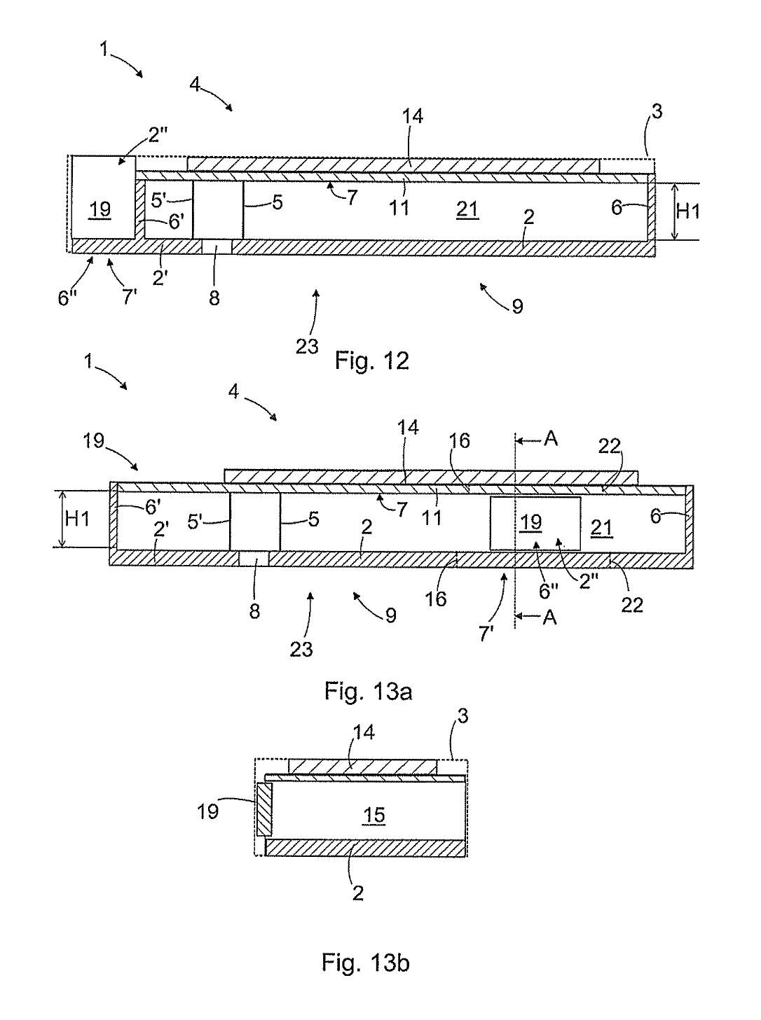

FIG. 12 is a schematic side view of fourth example antenna arrangement and electronic device in partial cross-section. The secondary antenna 19 is higher than the first height H1 of the main antenna 23. The secondary antenna 19 may have any known antenna configuration.

According to an embodiment the height of the secondary antenna corresponds at least substantially to sum of the first height H1+the thickness of a circuit board 11+the thickness of a display 14.

The wrap structure 9 extends under the secondary antenna 19, but this is not a compulsory feature.

FIG. 13a is a schematic side view of fifth example antenna arrangement and electronic device in partial cross-section, and FIG. 13b is cross-section along line A-A shown in FIG. 13a. The secondary antenna 19 is arranged on a side of the main antenna 23. As can be seen in FIG. 13b, the secondary antenna 19 may extend between the radiator element 2, 2′ and the ground plane 7 of the main antenna 23. In an embodiment the secondary antenna 19 is arranged completely between the radiator element and the ground plane of the main antenna 23. In another embodiment the secondary antenna 19 does not extend at all between the radiator element and the ground plane of the main antenna 23. Again, any known antenna type may be utilized in the secondary antenna 19.

The first ground plane 7 may serve as the ground plane of the secondary antenna 19, i.e. as the second ground plane 7′. In another embodiment the radiator element 2, 2′ of the main antenna 23 functions as the second ground plane 7′. In still another embodiment, both the radiator element 2, 2′ and the first ground plane 7 function as the second ground plane 7′.The height of the secondary antenna 19 corresponds here to the height of the main antenna 23, but this is not an essential feature.

The location of the secondary antenna 19 may vary. For example, it may be arranged on the side of the larger radiator element 2 as shown in Figures 13a, 13b, or on the side of the smaller radiator element 2′, or it may extend on the side of both radiator elements 2, 2′.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

According to an embodiment, for instance, it is possible to connect two or more radiator elements 2, 2′, 2″ to each other to obtain the required bandwidth.

The radiator element 2, 2′ in FIG. 2 is a planar rectangular in basic shape. According to another embodiment the radiator element 2, 2′ may comprise shapes that are at least to some extent three-dimensional.

The radiator element 2, 2′, 2″ may have a single layer structure or it may comprise several sub-layers, of which at least one is electrically conductive.

### REFERENCE SYMBOLS

1 antenna arrangement

2, 2′ radiator element

3 cover

4 electronic device

5, 5′ feed element

6, 6′ grounding element

7 ground plane

8 insulation gap

9, 9′ wrap structure

10 grounded area

11 circuit board

12 electric component

13 foil

14 display unit

15 window unit

16 interior

17 coating

18 battery

19 secondary antenna

20 height element

14 display unit

21 interior

22 break line

23 main antenna

1. An antenna arrangement of an electronic device, the antenna arrangement comprising at least two radiator elements,
the radiator element being connected through a single feed element to electronics of the electronic device and that a non-conductive insulation gap is arranged between said at least two radiator elements,
the radiator elements being part of a cover of said electronic device.

2. An antenna arrangement as claimed in claim 1, wherein the radiator elements are made of metal, such as aluminium, zinc, steel, magnesium, copper or an alloy.

3. An antenna arrangement as claimed in claim 1, wherein the material of the radiator element is an electrically conductive plastic or plastic mixture.

4. An antenna arrangement as claimed in claim 1, wherein the radiator elements comprise metal and plastic.

5. An antenna arrangement as claimed in claim 1, wherein the insulation gap comprises an air gap.

6. An antenna arrangement as claimed in claim 1, wherein the feed elements are galvanically coupled elements.

7. An antenna arrangement as claimed in claim 1, wherein the feed elements are capacitively coupled elements.

8. An antenna arrangement as claimed in claim 1, wherein the feed elements are inductively coupled elements.

9. An antenna arrangement as claimed in claim 1, wherein the ground plane of the antenna arrangement is configured to a circuit board, display unit or battery of the device.

10. An antenna arrangement as claimed in claim 1, wherein the radiator elements are part of a wrap structure establishing an interior in the electronic device.

11. An antenna arrangement as claimed in claim 1, wherein in the antenna arrangement further comprising a third radiator element providing a radiator element of a secondary antenna.

12. An electronic device, comprising at least two radiator elements of an antenna arrangement,
wherein the radiator element is configured to a single feed element and that
a non-conductive insulation gap is arranged between said at least two radiator elements,
the radiator elements being part of a cover of the electronic device.

13. An electronic device as claimed in claim 12, wherein the radiator elements form at least part of the outer surface of the cover.

14. An electronic device as claimed in claim 13, wherein the radiator elements form a major part of the outer surface of the cover.

15. An electronic device as claimed in claim 14, wherein the radiator elements form a major part of the outer surface of the back cover.

16. An electronic device as claimed in claim 12, wherein the radiator elements are made of metal, such as aluminium, zinc, steel, magnesium, copper or an alloy.

17. An electronic device as claimed in claim 12, wherein the material of the radiator element is an electrically conductive plastic or plastic mixture.

18. An electronic device as claimed in claim 12, wherein the radiator elements comprise metal and plastic.

19. An electronic device as claimed in claim 12, wherein the insulation gap comprises an air gap.

20. An electronic device as claimed in claim 12, wherein the insulation gap comprises plastic.

21. An electronic device as claimed in claim 12, wherein the insulation gap is arranged on back cover side of the cover part.

22. An electronic device as claimed in claim 12, wherein the radiator elements are part of a wrap structure establishing an interior in the electronic device.

23. An electronic device as claimed in claim 22, wherein the wrap structure is arranged to establish a grounding element.
